(19) United States
(12) Patent Application Publication
(10) Pub. No.: US 2014/0282267 A1
(43) Pub. Date: Sep. 18, 2014

(54) Interaction with a Three-Dimensional Virtual Scenario

(71) Applicants: Leonhard Vogelmeier, Dachau (DE); David Wittmann, Muenchen (DE)

(72) Inventors: Leonhard Vogelmeier, Dachau (DE); David Wittmann, Muenchen (DE)

(73) Assignee: EADS Deutschland GmbH, Ottobrunn (DE)

(21) Appl. No.: 14/343,440

(22) PCT Filed: Sep. 6, 2012
(86) PCT No.: PCT/DE2012/000892

§ 371 Date: May 23, 2014

(30) Foreign Application Priority Data
Sep. 8, 2011 (DE) 10 2011 112 618.3

(51) Int. Cl. G06F 3/0484; G06F 3/0481

(52) U.S. Cl. CPC G06F 3/04842; G06F 3/04815
USPC 715/852

(57) ABSTRACT

A display device for a three-dimensional virtual scenario for selecting objects in the virtual scenario provides feedback upon successful selection of an object. The display device is designed to output a haptic or tactile, optical or acoustic feedback upon selection of a virtual object.

### FIELD OF THE INVENTION

Exemplary embodiments of the invention relate to display devices for a three-dimensional virtual scenario. In particular, exemplary embodiments of the invention relate to display devices for a three-dimensional virtual scenario for the selection of objects in the virtual scenario with feedback upon selection of one of the objects, a workplace device for monitoring a three-dimensional virtual scenario and interaction with a three-dimensional virtual scenario, a use of a workplace device for the monitoring of a three-dimensional virtual scenario for the monitoring of airspaces, as well as a method for selecting objects in a three-dimensional scenario.

### BACKGROUND OF THE INVENTION

Systems for the monitoring of airspace provide a two-dimensional representation of a region of an airspace to be monitored on a display. The display is performed here in the form of a top view similar to a map. Information pertaining to a third dimension, for example information on the flying altitude of an airplane or of another aircraft, is depicted in writing or in the form of a numerical indication.

### SUMMARY OF THE INVENTION

Exemplary embodiments of the invention are directed to a display device for a three-dimensional virtual scenario that enables easy interaction with the virtual scenario by the observer or operator of the display device.

Many of the features described below with respect to the display device and the workplace device can also be implemented as method steps, and vice versa.

According to a first aspect of the invention, a display device for a three-dimensional virtual scenario for the selection of objects in the virtual scenario with feedback upon selection of an object is provided which has a representation unit for a virtual scenario and a touch unit for the touch-controlled selection of an object in the virtual scenario. The touch unit is arranged in a display surface of the virtual scenario and, upon selection of an object in the three-dimensional virtual scenario, outputs the feedback about this to an operator of the display device.

The representation unit can be based on stereoscopic display technologies, which are particularly used for the evaluation of three-dimensional models and data sets. Stereoscopic display technologies enable an observer of a three-dimensional virtual scenario to have an intuitive understanding of spatial data. However, due to the limited and elaborately configured possibilities for interaction, as well as due to the quick tiring of the user, these technologies are currently not used for longer-term activities.

When observing three-dimensional virtual scenarios, a conflict can arise between convergence (position of the ocular axes relative to each other) and accommodation (adjustment of the refractive power of the lens of the observer's eyes). During natural vision, convergence and accommodation are coupled to each other, and this coupling must be eliminated when observing a three-dimensional virtual scenario. This is because the eye is focused on an imaging representation unit, but the ocular axes have to aim at the virtual objects, which might be located in front of or behind the imaging representation unit in space or the virtual three-dimensional scenario. The elimination of the coupling of convergence and accommodation can place a strain on and thus lead to tiring of the human visual apparatus to the point of causing headaches and nausea in an observer of a three-dimensional virtual scene. In particular, the conflict between convergence and accommodation also occurs as a result of an operator, while interacting directly with the virtual scenario, interacting with objects of the virtual scenario using their hand, for example, in which case the actual position of the hand overlaps with the virtual objects. In that case, the conflict between accommodation and convergence can be intensified.

The direct interaction of a user with a conventional three-dimensional virtual scenario can require that special gloves be worn, for example. These gloves enable, for one, the detection of the positioning of the user's hands and, for another, a corresponding vibration can be triggered, for example, upon contact with virtual objects. In this case, the position of the hand is usually detected using an optical detection system. To interact with the virtual scenario, a user typically moves their hands in the space in front of the user. The inherent weight of the arms and the additional weight of the gloves can limit the time of use, since the user can quickly experience fatigue.

Particularly in the area of airspace surveillance and aviation, there are situations in which two types of information are required in order to gain a good understanding of the current airspace situation and its future development. These are a global view of the overall situation on the one hand and a more detailed view of the elements relevant to a potential conflict situation on the other hand. For example, an air traffic controller who needs to resolve a conflict situation between two aircraft must analyze the two aircraft trajectories in detail while also incorporating the other basic conditions of the surroundings into their solution in order to prevent the solution of the current conflict from creating a new conflict.

While perspective displays for representing spatial scenarios enable a graphic representation of a three-dimensional scenario, for example of an airspace, they cannot be suited to security-critical applications due to the ambiguity of the representation.

According to one aspect of the invention, a representation of three-dimensional scenarios is provided that simultaneously provides both an overview and detailed representation, provides a simple and direct way for a user to interact with the three-dimensional virtual scenario, and provides usage that causes little fatigue and protects the user's visual apparatus.

The representation unit is designed to give a user the impression of a three-dimensional scenario. In doing so, the representation unit can have at least two projection devices that project a different image for each individual eye of the observer, so that a three-dimensional impression is evoked in the observer. However, the representation unit can also be designed to display differently polarized images, with glasses of the observer having appropriately polarized lenses enabling each eye to perceive an image, this creating a three-dimensional impression in the observer. It is worth noting that any technology for the representation of a three-dimensional scenario can be used as a representation unit in the context of the invention.

The touch unit is an input unit for the touch-controlled selection of an object in the three-dimensional virtual scenario. The touch unit can be transparent, for example, and arranged in the three-dimensional represented space of the virtual scenario, so that an object of the virtual scenario is selected when the user uses a hand or both hands to grasp in the three-dimensional represented space and touch the touch unit. The touch unit can be arranged at any location in the three-dimensional represented spaces or outside of the three-dimensional represented space. The touch unit can be designed as a plane or as any geometrically shaped surface. Particularly, the touch unit can be embodied as a flexibly shapeable element for enabling the touch unit to be adapted to the three-dimensional virtual scenario.

The touch unit can, for example, have capacitive or resistive measurement systems or infrared-based lattices for determining the coordinates of one or more contact points at which the user is touching the touch unit. For example, depending on the coordinates of a contact point, the object in the three-dimensional virtual scenario is selected that is nearest the contact point.

According to one embodiment of the invention, the touch unit is designed to represent a selection region for the object. In that case, the object is selected by touching the selection area.

A computing device can, for example, calculate a position of the selection areas in the three-dimensional virtual scenario so that the selection areas are represented on the touch unit. Therefore, a selection area is activated as a result of the touch unit being touched by the user at the corresponding position in the virtual scenario.

As will readily be understood, the touch unit can be designed to represent a plurality of selection areas for a plurality of objects, each selection area being allocated to an object in the virtual scenario.

It is particularly the direct interaction of the user with the virtual scenario without the use of aids, such as gloves, that enables simple operation and prevents the user from becoming fatigued.

According to another embodiment of the invention, the feedback upon selection of one of the objects from the virtual scenario occurs at least in part through a vibration of the touch unit or through focused ultrasound waves aimed at the operating hand.

Because a selection area for an object of the virtual scenario lies on the touch unit in the virtual scenario, the selection is already signaled to the user merely through the user touching an object that is really present, i.e., the touch unit, with their finger. Additional feedback upon selection of the object in the virtual scenario can also be provided with vibration of the touch unit when the object is successfully selected.

The touch unit can be made to vibrate in its entirety, for example with the aid of a motor, particularly a vibration motor, or individual regions of the touch unit can be made to vibrate.

In addition, piezoactuators can also be used as vibration elements, for example, the piezoactuators each being made to vibrate at the contact point upon selection of an object in the virtual scenario, thus signaling the successful selection of the object to the user.

According to another embodiment of the invention, the touch unit has a plurality of regions that can be optionally selected for tactile feedback via the selection of an object in the virtual scenario.

The touch unit can be embodied so as to permit the selection of several objects at the same time. For example, one object can be selected with a first hand and another object with a second hand of the user. In order to provide the user with assignable feedback, the touch unit can be selected in the region of a selection area for an object for outputting of a tactile feedback, that is, to execute a vibration, for example. This makes it possible for the user to recognize, particularly when selecting several objects, which of the objects has been selected and which have not yet been.

Moreover, the touch unit can be embodied so as to enable changing of the map scale and moving of the area of the map being represented.

Tactile feedback is understood, for example, as being a vibration or oscillation of a piezoelectric actuator.

According to another embodiment of the invention, the feedback as a result of the successful selection of an object in the three-dimensional scenario occurs at least in part through the outputting of an optical signal.

The optical signal can occur alternatively or in addition to the tactile feedback upon selection of an object.

Feedback by means of an optical signal is understood here as the emphasizing or representation of a selection indicator. For example, the brightness of the selected object can be changed, or the selected object can be provided with a frame or edging, or an indicator element pointing to this object is displayed beside the selected object in the virtual scenario.

According to another embodiment of the invention, the feedback as a result of the selection of an object in the virtual scenario occurs at least in part through the outputting of an acoustic signal.

In that case, the acoustic signal can be outputted alternatively to the tactile feedback and/or the optical signal, or also in addition to the tactile feedback and/or the optical signal.

An acoustic signal is understood here, for example, as the outputting of a short tone via an output unit, for example a speaker.

According to another embodiment of the invention, the representation unit has an overview area and a detail area, the detail area representing a selectable section of the virtual scene of the overview area.

This structure allows the user to observe the entire scenario in the overview area while observing a user-selectable smaller area in the detail area in greater detail.

The overview area can be represented, for example, as a two-dimensional display, and the detail area as a spatial representation. The section of the virtual scenario represented in the detail area can be moved, rotated or resized.

For example, this makes it possible for an air traffic controller who is monitoring an airspace to have, in a clear and simple manner, an overview of the entire airspace situation in the overview area while also having a view of potential conflict situations in the detail area. The invention enables the operator to change the detail area according to their respective needs, which is to say that any area of the overview representation can be selected for the detailed representation. It will readily be understood that this selection can also be made such that a selected area of the detailed representation is displayed in the overview representation.

By virtue of the depth information additionally received in the spatial representation, the air traffic controller receives, in an intuitive manner, more information than through a two-dimensional representation with additional written and numerical information, such as flight altitude.

The above portrayal of the overview area and detail area enables the simultaneous monitoring of the overall scenario and the processing of a detailed representation at a glance. This improves the situational awareness of the person processing a virtual scenario, thus increasing processing performance.

According to another aspect of the invention, a workplace device for monitoring a three-dimensional virtual scenario with a display device for a three-dimensional virtual scenario for the selection of objects in the virtual scenario with feedback upon selection of one of the objects is provided as described above and in the following.

For example, the workplace device can also be used to control unmanned aircraft or for the monitoring of any scenarios by one or more users.

As described above and in the following, the workplace device can of course have a plurality of display devices and even one or more conventional displays for displaying additional two-dimensional information. For example, these displays can be coupled with the display device such that a mutual influencing of the represented information is enabled. For instance, a flight plan can be displayed on one display and, upon selection of an entry from the flight plan, the corresponding aircraft can be displayed in the overview area and/or in the detail area. The displays can particularly also be arranged such that the display areas of all of the displays merge into each other or several display areas are displayed on one physical display.

Moreover, the workplace device can have input elements that can be used alternatively or in addition to the direct interaction with the three-dimensional virtual scenario.

The workplace device can have a so-called computer mouse, a keyboard or an interaction device that is typical for the application, for example that of an air traffic control workplace.

Likewise, all of the displays and representation units can be conventional displays or touch-sensitive displays and representation units (so-called touch screens).

According to another aspect of the invention, a workplace device is provided for the monitoring of airspaces as described above and in the following.

The workplace device can also be used for monitoring and controlling unmanned aircraft, as well as for the analysis of a recorded three-dimensional scenario, for example for educational purposes.

Likewise, the workplace device can also be used for controlling components, such as a camera or other sensors, of an unmanned aircraft.

The workplace device can be designed, for example, to represent a restricted zone or a hazardous area in the three-dimensional scenario. In doing so, the three-dimensional representation of the airspace makes it possible to recognize easily and quickly whether an aircraft is threatening, for example, to fly through a restricted zone or hazardous area. A restricted zone or a hazardous area can be represented, for example, as virtual bodies of the size of the restricted zone or hazardous area.

According to another aspect of the invention, a method is provided for selecting objects in a three-dimensional scenario.

Here, in a first step, a selection area of a virtual object is touched in a display surface of a three-dimensional virtual scenario. In a subsequent step, feedback is outputted to an operator upon successful selection of the virtual object.

According to one embodiment of the invention, the method further comprises the following steps: displaying a selection element in the three-dimensional virtual scenario, moving of the selection element according to the movement of the operator's finger on the display surface, and selection of an object in the three-dimensional scenario by causing the selection element to overlap with the object to be selected. Here, the displaying of the selection element, the moving of the selection element and the selection of the object occur after touching of the selection surface.

The selection element can be represented in the virtual scenario, for example, if the operator touches the touch unit. Here, the selection element is represented in the virtual scenario, for example, as a vertically extending light cone or light cylinder and moves through the three-dimensional virtual scenario according to a movement of the operator's finger on the touch unit. If the selection element encounters an object in the three-dimensional virtual scenario, then this object is selected for additional operations insofar as the user leaves the selection element for a certain time on the object of the three-dimensional virtual scenario in a substantially stationary state. For example, the selection of the object in the virtual scenario can occur after the selection element overlaps an object for one second without moving. The purpose of this waiting time is to prevent objects in the virtual scenario from being selected even though the selection element was merely moved past them.

The representation of a selection element in the virtual scenario simplifies the selection of an object and makes it possible for the operator to select an object without observing the position of their hand in the virtual scenario.

The selection of an object is therefore achieved by causing, through movement of a hand, the selection element to overlap with the object to be selected, which is made possible by the fact that the selection element runs vertically through the virtual scenario, for example in the form of a light cylinder.

Causing the selection element to overlap with an object in the virtual scenario means that the virtual spatial extension of the selection element coincides in at least one point with the coordinates of the virtual object to be selected.

According to another aspect of the invention, a computer program element is provided for controlling a display device for a three-dimensional virtual scenarios for the selection of objects in the virtual scenario with feedback upon selection of one of the objects that is designed to execute the method for selecting virtual objects in a three-dimensional virtual scenario as described above and in the following when the computer program element is executed on a processor of a computing unit.

The computer program element can be used to instruct a processor or a computing unit to execute the method for selecting virtual objects in a three-dimensional virtual scenario.

According to another aspect of the invention, a computer-readable medium with the computer program element is provided as described above and in the following.

A computer-readable medium can be any volatile or non-volatile storage medium, for example a hard drive, a CD, a DVD, a diskette, a memory card or any other computer-readable medium or storage medium.

Below, exemplary embodiments of the invention will be described with reference to the figures.

### BRIEF DESCRIPTION OF THE FIGURES

FIG. 1 shows a side view of a workplace device according to one exemplary embodiment of the invention.

FIG. 2 shows a perspective view of a workplace device according to another exemplary embodiment of the invention.

FIG. 3 shows a schematic view of a display device according to one exemplary embodiment of the invention.

FIG. 4 shows a schematic view of a display device according to another exemplary embodiment of the invention.

FIG. 5 shows a side view of a workplace device according to one exemplary embodiment of the invention.

FIG. 6 shows a schematic view of a display device according to one exemplary embodiment of the invention.

FIG. 7 shows a schematic view of a method for selecting objects in a three-dimensional scenario according to one exemplary embodiment of the invention.

### DETAILED DESCRIPTION OF THE EXEMPLARY EMBODIMENTS

FIG. 1 shows a workplace device 200 for an operator of a three-dimensional scenario. The workplace device 200 has display device 100 with a representation unit 110 and a touch unit 120. The touch unit 120 can particularly overlap with a portion of the representation unit 110. However, the touch unit can also overlap over the entire representation unit 110. As will readily be understood, the touch unit is transparent in such a case so that the operator of the workplace device or the observer of the display device can continue to have a view of the representation unit. In other words, the representation unit 110 and the touch unit 120 form a touch-sensitive display.

It should be pointed out that the embodiments portrayed above and in the following apply accordingly with respect to the construction and arrangement of the representation unit 110 and the touch unit 120 to the touch unit 120 and the representation unit 110 as well. The touch unit can be embodied such that it covers the representation unit, which is to say that the entire representation unit is provided with a touch-sensitive touch unit, but it can also be embodied such that only a portion of the representation unit is provided with a touch-sensitive touch unit.

The representation unit 110 has a first display area 111 and a second display area 112, the second display area being angled in the direction of the user relative to the first display area such that the two display areas exhibit an inclusion angle α 115.

As a result of their angled position with respect to each other and an observer position 195, the first display area 111 of the representation unit 110 and the second display area 112 of the representation unit 110 span a display space 130 for the three-dimensional virtual scenario.

The display space 130 is therefore the spatial volume in which the visible three-dimensional virtual scene is represented.

An operator who uses the seat 190 during use of the workplace device 200 can, in addition to the display space 130 for the three-dimensional virtual scenario, also use the workplace area 140, in which additional touch-sensitive or conventional displays can be located.

The inclusion angle α 115 can be dimensioned such that all of the virtual objects in the display space 130 can lie within arm's reach of the user of the workplace device 200. An inclusion angle α that lies between 90 degrees and 150 degrees results in a particularly good adaptation to the arm's reach of the user. The inclusion angle α can also be adapted, for example, to the individual needs of an individual user and/or extend below or above the range of 90 degrees to 150 degrees. In one exemplary embodiment, the inclusion angle α is 120 degrees.

The greatest possible overlapping of the arm's reach or grasping space of the operator with the display space 130 supports an intuitive, low-fatigue and ergonomic operation of the workplace device 200.

Particularly the angled geometry of the representation unit 110 is capable of reducing the conflict between convergence and accommodation during the use of stereoscopic display technologies.

The angled geometry of the representation unit can minimize the conflict between convergence and accommodation in an observer of a virtual three-dimensional scene by positioning the virtual objects as closely as possible to the imaging representation unit as a result of the angled geometry.

Since the position of the virtual objects and the overall geometry of the virtual scenario results from each special application, the geometry of the representation unit, for example the inclusion angle α, can be adapted to the respective application.

For airspace surveillance, the three-dimensional virtual scenario can be represented, for example, such that the second display area 112 of the representation unit 110 corresponds to the virtually represented surface of the Earth or a reference surface in space.

The workplace device according to the invention is therefore particularly suited to longer-term, low-fatigue processing of three-dimensional virtual scenarios with the integrated spatial representation of geographically referenced data, such as, for example, aircraft, waypoints, control zones, threat spaces, terrain topographies and weather events, with simple, intuitive possibilities for interaction with simultaneous representation of an overview area and a detail area.

As will readily be understood, the representation unit 110 can also have a rounded transition from the first display area 111 to the second display area 112. As a result, a disruptive influence of an actually visible edge between the first display area and the second display area on the three-dimensional impression of the virtual scenario is prevented or reduced.

Of course, the representation unit 110 can also be embodied in the form of a circular arc.

The workplace device as described above and in the following therefore enables a large stereoscopic display volume or display space. Furthermore, the workplace device makes it possible for a virtual reference surface to be positioned on the same plane in the virtual three-dimensional scenario, for example surface terrain, as the actually existing representation unit and touch unit.

As a result, the distance of the virtual objects from the surface of the representation unit can be reduced, thus reducing a conflict between convergence and accommodation in the observer. Moreover, disruptive influences on the three-dimensional impression are thus reduced which result from the operator grasping into the display space with their hand and the observer thus observing a real object, i.e., the operator's hand, and virtual objects at the same time.

The touch unit 120 is designed to output feedback to the operator upon touching of the touch unit with the operator's hand.

Particularly in the case of an optical or acoustic feedback to the operator, the feedback can be performed by having a detection unit (not shown) detect the contact coordinates on the touch unit and having the representation unit, for example, output an optical feedback or a tone outputting unit (not shown) output an acoustic feedback.

The touch unit can output haptic or tactile feedback by means of vibration or oscillations of piezoactuators.

FIG. 2 shows a workplace device 200 with a display device 100 that is designed to represent a three-dimensional virtual scenario, and also with three conventional display elements 210, 211, 212 for the two-dimensional representation of graphics and information, as well as with two conventional input and interaction devices, such as a computer mouse 171 and a so-called space mouse 170, this being an interaction device with six degrees of freedom and with which elements can be controlled in space, for example in a three-dimensional scenario.

The three-dimensional impression of the scenario represented by the display device 100 is created in an observer as a result of their putting on a suitable pair of glasses 160.

As is common in stereoscopic display technologies, the glasses are designed to supply the eyes of an observer with different images so that the observer is given the impression of a three-dimensional scenario. The glasses 160 have a plurality of so-called reflectors 161 that serve to detect the eye position of an observer in front of the display device 100, thus adapting the reproduction of the three-dimensional virtual scene to the observer's position. To do this, the workplace device 200 can have a positional detection unit (not shown), for example, that detects the eye position on the basis of the position of the reflectors 161 by means of a camera system with a plurality of cameras, for example.

FIG. 3 shows a perspective view of a display device 100 with a representation unit 110 and a touch unit 120, the representation unit 110 having a first display area 111 and a second display area 112.

In the display space 130, a three-dimensional virtual scenario is indicated with several virtual objects 301. In a virtual display surface 310, a selection area 302 is indicated for each virtual object in the display space 130. Each selection area 302 can be connected via a selection element 303 to the virtual area 301 allocated to this selection area.

The selection element 303 facilitates for a user the allocation of a selection area 302 to a virtual object 301. A procedure for the selection of a virtual object can thus be accelerated and simplified.

The display surface 310 can be arranged spatially in the three-dimensional virtual scenario such that the display surface 310 overlaps with the touch unit 120. The result of this is that the selection areas 302 also lie on the touch unit 120. The selection of a virtual object 301 in the three-dimensional virtual scene thus occurs as a result of the operator touching the touch unit 120 with their finger on the place in which the selection area 302 of the virtual object to be selected is placed.

The touch unit 120 is designed to send the contact coordinates of the operator's finger to an evaluation unit which reconciles the contact coordinates with the display coordinates of the selection areas 302 and can therefore determine the selected virtual object.

The touch unit 120 can particularly be embodied such that it reacts to the touch of the operator only in the places in which a selection area is displayed. This enables the operator to rest their hands on the touch unit such that no selection area is touched, such resting of the hands preventing fatigue on the part of the operator and supporting easy interaction with the virtual scenario.

The described construction of the display device 100 therefore enables an operator to interact with a virtual three-dimensional scene and, as a result of that alone, receive real feedback that they, in selecting the virtual objects, in fact actually feel the selection areas 302 lying on the actually existing touch unit 120 through contact with their hand or a finger with the touch unit 120.

When a selection area 302 is touched, the successful selection of a virtual object 301 can be signaled to the operator, for example through vibration of the touch unit 120.

Both the entire touch unit 120 can vibrate, or only areas of the touch unit 120. For instance, the touch unit 120 can be made to vibrate only on an area the size of the selected selection area 302. This can be achieved, for example, through the use of oscillating piezoactuators in the touch unit, the piezoactuators being made to oscillate at the corresponding position after detection of the contact coordinates of the touch unit.

Besides the selection of the virtual objects 301 via a selection area 302, the virtual objects can also be selected as follows: When the touch unit 120 is touched at the contact position, a selection element is displayed in the form of a light cylinder or light cone extending vertically in the virtual three-dimensional scene and this selection element is guided with the movement of the finger on the touch unit 120. A virtual object 301 is then selected by making the selection element overlap with the virtual object to be selected.

In order to prevent inadvertent selection of a virtual object, the selection can occur with a delay which is such that a virtual object is only selected if the selection element remains overlapping with the corresponding virtual object for a certain time. Here as well, the successful selection can be signaled through vibration of the touch unit or through oscillation of piezoactuators and optically or acoustically.

FIG. 4 shows a display device 100 with a representation unit 110 and a touch unit 120. In a first display area 111, an overview area is represented in two-dimensional form, and in a display space 130, a partial section 401 of the overview area is reproduced in detail as a three-dimensional scenario.

In the detail area 402, the objects located in the partial section of the overview area are represented as virtual three-dimensional objects 301.

The display device 100 as described above and in the following enables the operator to change the detail area 402 by moving the partial section in the overview area 401 or by changing the excerpt of the overview area in the three-dimensional representation in the detail area 402 in the direction of at least one of the three coordinates x, y, z shown.

FIG. 5 shows a workplace device 200 with a display device 100 and a user 501 interacting with the depicted three-dimensional virtual scenario. The display device 100 has a representation unit 110 and a touch unit 120 which, together with the eyes of the operator 501, span the display space 130 in which the virtual objects 301 of the three-dimensional virtual scenario are located.

A distance of the user 501 from the display device 100 can be dimensioned here such that it is possible for the user to reach a majority or the entire display space 130 with at least one of their arms. Consequently, the actual position of the hand 502 of the user, the actual position of the display device 100 and the virtual position of the virtual objects 301 in the virtual three-dimensional scenario deviate from each other as little as possible, so that a conflict between convergence and accommodation in the user's visual apparatus is reduced to a minimum. This construction can support a longer-term, concentrated use of the workplace device as described above and in the following by reducing the side effects in the user of a conflict between convergence and accommodation, such as headache and nausea.

The display device as described above and in the following can of course also be designed to display virtual objects whose virtual location, from the user's perspective, is behind the display surface of the representation unit. In that case, however, no direct interaction of the user with the virtual object is possible, since the user cannot grasp through the representation unit.

FIG. 6 shows a display device 100 for a three-dimensional virtual scenario with a representation unit 110 and a touch unit 120. Virtual three-dimensional objects 301 are displayed in the display space 130.

Arranged in the three-dimensional virtual scene is a virtual surface 601 on which a marking element 602 can be moved. The marking element 602 moves only on the virtual surface 601, whereby the marking element 602 has two degrees of freedom in its movement. In other words, the marking element 602 is designed to perform a two-dimensional movement. The marking element can therefore be controlled, for example, by means of a conventional computer mouse.

The selection of the virtual object in the three-dimensional scenario is achieved by the fact that the position is at least one eye 503 of the user is detected with the aid of the reflectors 161 on glasses worn by the user, and a connecting line 504 from the detected position of the eye 503 over the marking element 602 and into the virtual three-dimensional scenario in the display space 130 is calculated.

The connecting line can of course also be calculated on the basis of a detected position of both eyes of the observer. Furthermore, the position of the user's eyes can be detected with or without glasses with appropriate reflectors. It should be pointed out that, in connection with the invention, any mechanisms and methods for detecting the position of the eyes can be used.

The selection of a virtual object 301 in the three-dimensional scenario occurs as a result of the fact that the connecting line 504 is extended into the display space 130 and the virtual object is selected whose virtual coordinates are crossed by the connecting line 504. The selection of a virtual object 301 is then designated, for example, by means of a selection indicator 603.

Of course, the virtual surface 601 on which the marking element 602 moves can also be arranged in the virtual scenario in the display space 130 such that, from the user's perspective, virtual objects 301 are located in front of/and/or behind the virtual surface 601.

As soon as the marking element 602 is moved on the virtual surface 601 such that the connecting line 504 crosses the coordinates of a virtual object 301, the marking element 602 can be represented in the three-dimensional scenario such that it takes on the virtual three-dimensional coordinates of the selected object with additional depth information or a change in the depth information. From the user's perspective, this change is then represented such that the marking element 602, as soon as a virtual object 301 is selected, makes a spatial movement toward the user or away from the user.

This enables interaction with virtual objects in three-dimensional scenarios by means of easy-to-handle two-dimensional interaction devices, such as a computer mouse, for example. Unlike special three-dimensional interaction devices with three degrees of freedom, this can mean simpler and more readily learned interaction with a three-dimensional scenario, since an input device with fewer degrees of freedom is used for the interaction.

FIG. 7 shows a schematic view of a method according to one exemplary embodiment of the invention.

In a first step 701 the touching of a selection surface of a virtual object occurs in a display surface of a three-dimensional virtual scenario. The selection surface is coupled to the virtual object such that a touching of the selection surface enables a clear determination of the appropriately selected virtual object.

In a second step 702, the displaying of a selection element occurs in the three-dimensional virtual scenario. The selection element can, for example, be a light cylinder extending vertically in the three-dimensional virtual scenario. The selection element can be displayed as a function of the contact duration of the selection surface, i.e., the selection element is displayed as soon as a user touches the selection surface and can be removed again as soon as the user removes their finger from the selection surface. As a result, it is possible for the user to interrupt or terminate the process of selecting a virtual object, for example because the user decides that they wish to select another virtual object.

In a third step 703, the moving of the selection element occurs according to a finger movement of the operator on the display surface. As long as the user does not remove their finger from the display surface or the touch unit, the once-displayed selected element remains in the virtual scenario and can be moved in the virtual scenario by performing a movement of the finger on the display surface or the touch unit. This enables a user to make the selection of a virtual object by incrementally moving the selection element to precisely the virtual object to be selected.

In a fourth step 704, the selection of an object in the three-dimensional scenario is achieved by the fact that the selection element is made to overlap with the object to be selected. The selection of the object can be done, for example, by causing the selection element to overlap with the object to be selected for a certain time, for example one second. Of course, the time period after which a virtual object is displayed as a virtual object can be set arbitrarily.

In a fifth step 705, the outputting of feedback to the operator occurs upon successful selection of the virtual object. As already explained above, the feedback can be haptic/tactile, optical or acoustic.

Finally, special mention should be made of the fact that the features of the invention, insofar as they were also depicted as individual examples, are not mutually exclusive for joint use in a workplace device, and complementary combinations can be used in a workplace device for representing a three-dimensional virtual scenario.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-14. (canceled)

15. A display device for a three-dimensional virtual scenario for selection of objects in the virtual scenario with feedback upon selection of one of the objects, comprising:
a representation unit configured to represent a virtual scenario; and
a touch unit configured for the touch-controlled selection of an object in the virtual scenario,
wherein the touch unit is arranged in a display surface of the virtual scenario, and
wherein the touch unit is configured to output feedback to an operator of the display device upon successful selection of the object in the virtual scenario.

16. The display device of claim 15, wherein
the touch unit is configured to represent a selection area for the object, and
the selection of the object occurs by touching the selection area.

17. The display device of claim 16, wherein the touch unit is configured to provide the feedback at least in part through vibration of the touch unit.

18. The display device of claim 17, wherein the touch unit is configured with a plurality of areas that can individually provide for tactile feedback.

19. The display device of claim 15, wherein the feedback is an optical signal.

20. The display device of claim 15, wherein the feedback is an acoustic signal.

21. The display device of claim 15, wherein
the representation unit includes an overview area and a detail area,
the detail area represent a selectable section of the virtual scene of the overview area.

22. A workplace device for monitoring a three-dimensional virtual scenario, the workplace device comprising:
a display device for a three-dimensional virtual scenario for selection of objects in the virtual scenario with feedback upon selection of one of the objects, the display device includes
a representation unit configured to represent a virtual scenario; and
a touch unit configured for the touch-controlled selection of an object in the virtual scenario,
wherein the touch unit is arranged in a display surface of the virtual scenario, and
wherein the touch unit is configured to output feedback to an operator of the display device upon successful selection of the object in the virtual scenario.

23. The workplace device of claim 22, wherein the workplace device is configured for surveillance of airspaces.

24. The workplace device of claim 22, wherein the workplace device is configured to monitor and control unmanned aircraft.

25. A method for selecting objects in a three-dimensional scenario, comprising the steps:
receiving an operator's touching of a selection surface of a virtual object in a display surface of a three-dimensional virtual scenario; and
outputting feedback to the operator upon successful selection of the virtual object.

26. The method of claim 25, further comprising the steps:
displaying a selection element in the three-dimensional virtual scenario;
moving the selection element according to a finger movement of the operator on the display surface; and
selecting an object in the three-dimensional scenario by making the selection element overlap with the object to be selected,
wherein the displaying of the selection element, the moving of the selection element and the selecting of the object are performed after receiving the operator's touching of the selection surface.

27. A non-transitory computer-readable medium storing instructions for selecting objects in a three-dimensional scenario, which when executed by a processor causes the processor to perform the steps:
receiving an operator's touching of a selection surface of a virtual object in a display surface of a three-dimensional virtual scenario; and
outputting feedback to the operator upon successful selection of the virtual object.

28. The non-transitory computer-readable medium of claim 27, further comprising instructions, which when executed by the processor causes the processor to perform the steps:
displaying a selection element in the three-dimensional virtual scenario;
moving the selection element according to a finger movement of the operator on the display surface; and
selecting an object in the three-dimensional scenario by making the selection element overlap with the object to be selected,
wherein the displaying of the selection element, the moving of the selection element and the selecting of the object are performed after receiving the operator's touching of the selection surface.
